(19) United States
(12) Patent Application Publication
(10) Pub. No.: US 2019/0184476 A1
(43) Pub. Date: Jun. 20, 2019

(54) Inside Pipe Cutter Lock

(71) Applicant: Fred Weinkam, Essex, MD (US)

(72) Inventor: Fred Weinkam, Essex, MD (US)

(21) Appl. No.: 16/221,889

(22) Filed: Dec. 17, 2018

Related U.S. Application Data
(60) Provisional application No. 62/599,744, filed on Dec. 17, 2017.

(51) Int. Cl. B23D 21/14

(52) U.S. Cl. CPC B23D 21/14; B23D 21/02

(57) ABSTRACT

Disclosed is an inside pipe cutter lock. The inside pipe cutter lock is intended for use as an attachment on a power drill. The inside pipe cutter lock locks a drill bit into position by grasping the edge of a chuck grip. This prevents the loss of an inside pipe cutter when cutting pipe from the inside out.

### RELATED APPLICATION(S)

Under provisions of 35 U.S.C. § 119e, the Applicant(s) claim the benefit of U.S. provisional application No. 62/599,744, filed Dec. 17, 2017, which is incorporated herein by reference.

### FIELD OF THE INVENTION

The present invention relates generally to power tool attachments and accessories, and in particular to an inside pipe cutter lock.

### BACKGROUND OF THE INVENTION

Drilling a hole in a length of pipe that has already been installed always presents the risk of losing the drill bit inside the pipe. Attempts to recover the lost drill bit are frustrating and time consuming. The worker often resorts to acquiring a new drill bit, which entails an additional delay, as well as the risk that the lost drill bit may cause additional problems such as a clogged drain.

Conventional solutions to this problem, include a hydraulic drilling bit and nozzle (disclosed in a U.S. Pat. No. 3,469,642; priority Oct. 15, 1968). The disclosed bit for drilling wells with hydraulic jets of abrasive-laden fluid, comprising a hollow bit body closed at its lower end and having a plurality of nozzles extending through the lower end and opening downwardly in position to cut a plurality of concentric grooves in the bottom of the borehole as the bit is rotated. Each of the nozzles comprises an elongated body formed with an internal profile embodying the invention which will operate in jet drilling bits for long periods of time without excessive erosion. A novel internal profile of the nozzles comprises an arcuate entrance section and a cylindrical throat portion tangent to the arcuate entrance section. The arcuate section is in the form of an arc of a circle of large diameter. The nozzles will have an increased life characteristic to further increase the advantages of hydraulic jet drilling. However, the hollow bit may break under stress. (See also U.S. Pat. No. 3,385,386).

Another known solution is an apparatus and method for avoiding a drill string becoming stuck during drilling (disclosed in a European Patent Appl. No. EP0354716A1; priority Aug. 3, 1988). The disclosed apparatus for avoiding stuck drilling equipment during drilling of a well bore over depth intervals where such equipment has stick in similar wells in a geological province includes data storage means for recording a multiplicity of well drilling variable quantities measured substantially simultaneously at a known depth in each of a multiplicity of wells. Such multiplicity of wells includes those in which drilling equipment has stuck and a multiplicity of similar wells where the drill string did not stick. Such data forms the input to multivariate statistical analysis means for calculating for all variables in all wells of each class the maximum separation of said classes from each other. The centroids of all well vectors representing each of the multiplicity of wells in each such classes are then recorded either numerically or by plotting. A currently drilling well relative to said classes is then established by means for calculating its well vector relative to the well classes. Such calculating means sums the products of the coefficient of each variable for the complete group of wells times the current value of each variable in the drilling well. The well vector is then recorded to plot or indicate which variable may be modified within allowable values to change the plotted location of the drilling well toward the centroid or mean of the wells that did not stick the drill string. However, the disclosed method may be costly to execute.

Another solution is a modular drill bit (disclosed in U.S. Pat. No. 5,224,560; priority Oct. 30, 1990), provides a modular drill bit which mounts legs within recesses in a body which are parallel to the central axis of the body using threaded studs with tapered outer portions, in conjunction with an attached pin having recesses therein receiving the upper ends of the legs. The lower ends of the legs terminate in spindles of open face configuration rotatably receiving cones thereon for rotation via a arrangement of bushings, roller bearings and thrust bearings, and a plurality of seals which slide and therefore rotate relative to both the leg spindle and the cone with the help of pressure compensating apparatus. Each cone is provided with cutting teeth which are inclined in the direction of cone rotation and which cover the cone surface in a manner which provides scraping of substantially the entire bottom surface of the hole being drilled and in a manner providing efficient scraping and crushing action. The cutting teeth are mounted in holes in the cone and then brazed in place, as are a plurality of ceramic buttons mounted within the extended portion of the cone to protect such portion and to provide backup gauging for a row of large cutting teeth mounted on an outer rim of the cone and having the cutting edges thereof inclined in alternating fashion. However, the modular bit includes a lot of small components, which may lead to expensive manufacturing processes (See also U.S. Pat. No. 5,199,516.)

Another solution is smart shuttles to complete oil and gas wells (disclosed in a U.S. Pat. No. 6,189,621; priority Aug. 16, 1999). The smart shuttles are used to complete oil and gas wells. Following drilling operations into a geological formation, a steel pipe is disposed in the wellbore. The steel pipe may be a standard casing installed into the wellbore using typical industry practices. Alternatively, the steel pipe may be a drill string attached to a rotary drill bit that is to remain in the wellbore following completion during so-called “one-pass drilling operations”. Using typical procedures in the industry, the well is “completed” by placing into the steel pipe various standard completion devices, many of which are conveyed into place using the drilling rig. Instead, with this invention, smart shuttles are used to convey into the steel pipe the various smart completion devices necessary to complete the oil and gas well. Smart shuttles may be attached to a wireline, to a coiled tubing, or to a wireline installed within coiled tubing. Of particular interest is a wireline conveyed smart shuttle that possesses an electrically operated internal pump that pumps fluid from below the shuttle, to above the shuttle, that in turn causes the smart shuttle to “pump itself down” and into a horizontal wellbore. Similar comments apply to coiled tubing conveyed smart shuttles. However, the user of smart shuttles may be costly.

Another solution is a monolithic self-sharpening rotary drill bit having tungsten carbide rods cast in steel alloys (disclosed in a U.S. Pat. No. 5,836,409; priority Sep. 7, 1994). The monolithic long lasting rotary drill bit for drilling a hole into a geological formation having at least one hardened rod which has a length of at least three times its diameter composed of hard material such as tungsten carbide that is cast into a relatively soft steel matrix material to make a rotary drill bit that compensates for wear on the bottom of the drill bit and that also compensates for lateral wear of the drill bit using passive, self-actuating mechanisms, triggered by bit wear to drill relatively constant diameter holes. However, the disclosed long tungsten carbide rods may be expensive to manufacture.

Accordingly, there is a need for an improved device which would prevent loss of the drill bit that may also overcome one or more of the abovementioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

According to some embodiments, an inside pipe cutter lock is disclosed. The inside pipe cutter lock is intended for use as an attachment on a power drill, and locks a drill bit into position by grasping the edge of a chuck grip. This prevents the loss of the inside pipe cutter when cutting pipe from the inside out.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front view of an inside pipe cutter lock, in accordance with a first exemplary embodiment.

FIG. 2 is a side view of the inside pipe cutter lock of FIG. 1.

FIG. 3 is a top view of the inside pipe cutter lock of FIG. 1.

FIG. 4 is a rear perspective view of the inside pipe cutter lock of FIG. 1.

FIG. 5 is a front perspective view of the inside pipe cutter lock of FIG. 1.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of an inside pipe cutter lock, embodiments of the present disclosure are not limited to use only in this context.

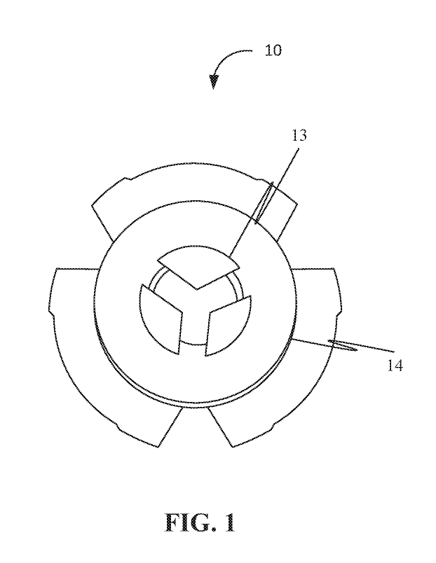

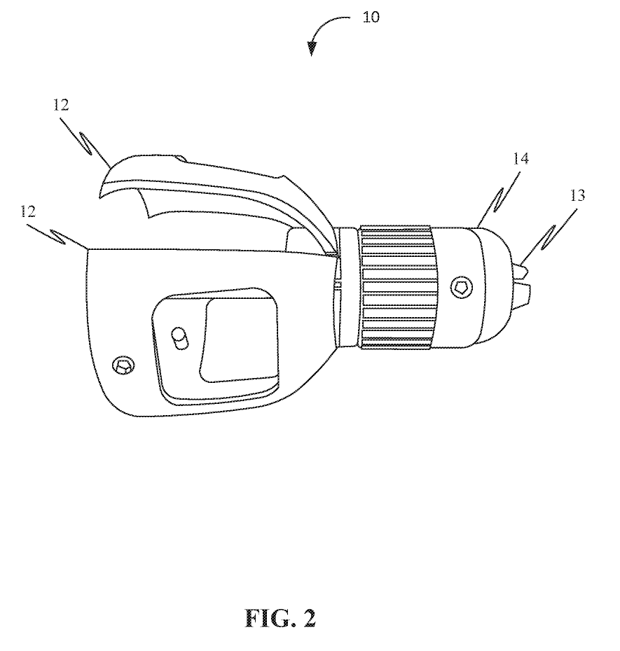

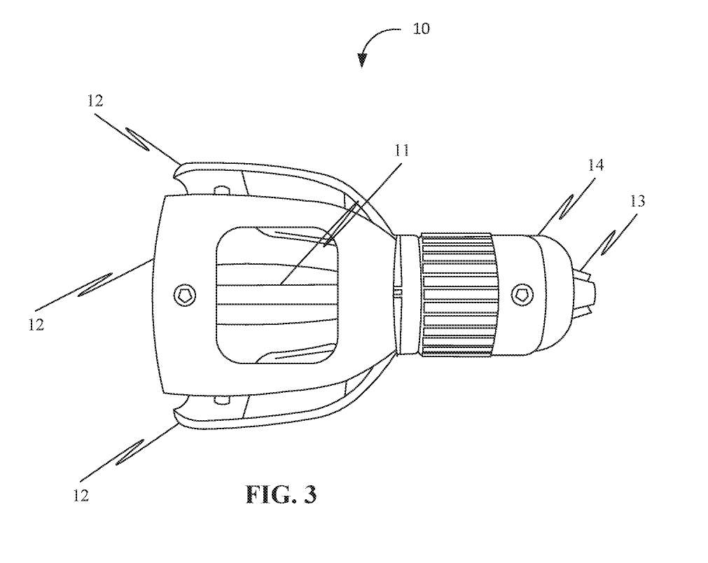

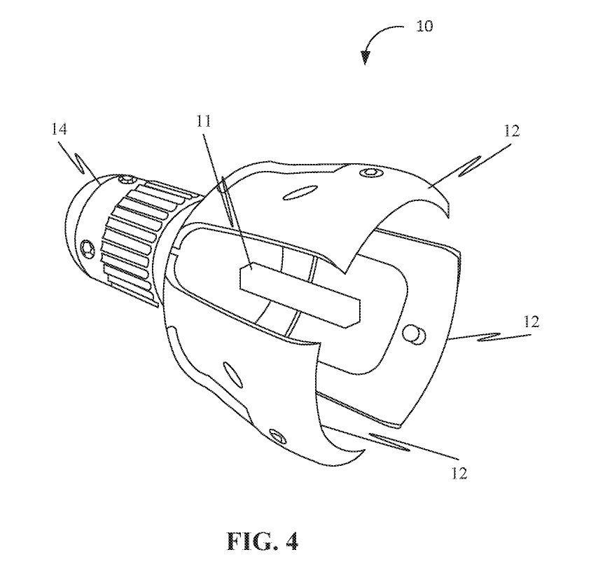

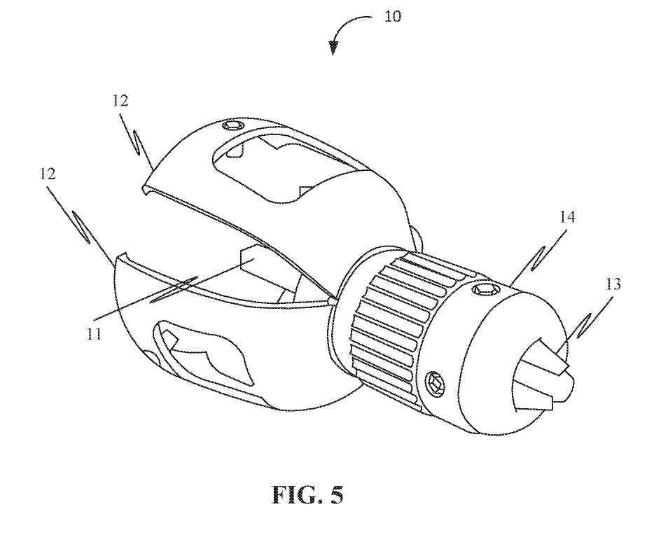

FIG. 1 is a front view of an inside pipe cutter lock 10, in accordance with a first exemplary embodiment. The inside pipe cutter lock 10 includes a chuck 13 and a chuck grip 14. FIG. 2 is a side view of the inside pipe cutter lock 10 showing flanges 12. FIG. 3 is a top view of the inside pipe cutter lock 10 showing a central shaft 11. FIG. 4 is a rear perspective view of the inside pipe cutter lock 10. FIG. 5 is a front perspective view of the inside pipe cutter lock 10.

The central shaft 11 is configured for insertion into the chuck of a power drill. By tightening the chuck, the inside pipe cutter lock 10 is secured to the power drill. Further, the three flanges 12 are tightened to grasp the edge of the chuck grip of the power drill. This further secures the inside pipe cutter lock 10 to the power drill.

Further, the chuck 13 and chuck grip 14 help securely affix a drill bit. This prevents the loss of the inside pipe cutter when cutting pipe from the inside out.

To use the first exemplary embodiment, the user affixes the inside pipe cutter lock 10 to the power drill by inserting the central shaft 11 into the chuck of the power drill, and tightening the chuck grip of the power drill. Then, the user may insert a drill bit into the chuck 13 of the inside pipe cutter lock 10, and tighten the chuck grip 14 of the inside pipe cutter lock 10. This also tightens the flanges 12, securing the inside pipe cutter lock 10 to the power drill.

The inside pipe cutter lock 10 is preferably manufactured from a rigid, durable material which provides substantial structural strength, such as steel, aluminum alloy, or brass. Components, component sizes, and materials listed above are preferable, but artisans will recognize that alternate components and materials could be selected without altering the scope of the invention.

Although the invention has been explained in relation to its preferred embodiment, it is to be understood that many other possible modifications and variations can be made without departing from the spirit and scope of the invention.

What is claimed is:

1. An inside pipe cutter lock, comprised of a lock, which provides a central shaft intended for insertion into the chuck of a power drill such that by tightening the chuck, the lock is secured to the power drill

2. The pipe cutter lock of claim 1, wherein the lock further provides three flanges which, when tightened, grasp the edge of the chuck grip of the power drill, further securing the lock to the power drill.

3. The pipe cutter lock of claim 1, wherein the lock further provides its own chuck and chuck grip, which may be used to securely affix a drill bit and prevent the loss of the inside pipe cutter when cutting pipe from the inside out.

4. The pipe cutter lock of claim 1, wherein the user affixes the lock to the power drill by inserting the shaft into the chuck of the power drill, and tightening the chuck grip of the power drill.

5. The pipe cutter lock of claim 1, wherein the user may then insert a drill bit into the chuck of the lock, and tighten the chuck grip of the lock, which also tightens the flanges, securing the lock to the power drill.

6. The pipe cutter lock of claim 1, wherein the lock is preferably manufactured from a rigid, durable material which provides substantial structural strength, such as steel, aluminum alloy, or brass.
